(19) United States
(12) Patent Application Publication
(10) Pub. No.: US 2026/0231208 A1
(43) Pub. Date: Aug. 6, 2026

(54) CHANNEL ACCESS PROCEDURE

(71) Applicant: Lenovo (Singapore) Pte. Limited, Singapore (SG)

(72) Inventors: Ali Ramadan Ali, Kraiburg (DE); Karthikeyan Ganesan, Nauheim (DE)

(73) Assignee: Lenovo (Singapore) Pte. Limited, Singapore (SG)

(21) Appl. No.: 19/154,899

(22) PCT Filed: Feb. 15, 2024
(86) PCT No.: PCT/IB2024/051441

§ 371 Date: Aug. 8, 2025

Related U.S. Application Data
(60) Provisional application No. 63/485,386, filed on Feb. 16, 2023.

(51) Int. Cl. H04W 74/0808; H04B 7/04

(52) U.S. Cl. CPC H04W 74/0808; H04B 7/04013

(57) ABSTRACT

Various aspects of the present disclosure relate to a network unit transmitting, to a reconfigurable intelligent surface (RIS) device, a first configuration message comprising a first mapping of each of one or more sensing beams of a set of sensing beams associated with the network unit to each of one or more sensing beams of a set of sensing beams associated with the RIS device; and performing a channel access procedure for each of the one or more sensing beams of the set of sensing beams associated with the network unit, wherein the channel access procedure is performed in parallel with the RIS device based at least in part on the first configuration message.

### RELATED APPLICATION

This application claims priority to U.S. patent application Ser. No. 63/485,386 filed Feb. 16, 2023 entitled “CHANNEL ACCESS PROCEDURE,” the disclosure of which is incorporated by reference herein in its entirety.

### TECHNICAL FIELD

The present disclosure relates to wireless communication, and more specifically to performing a channel access procedure for wireless communication over a shared spectrum (e.g., an unlicensed band).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In some wireless communications system that support NR-unlicensed (NR-U), a communication device (e.g., a network entity, a UE, or the like) may perform a channel access procedure, such as a listen before talk (LBT) procedure or clear channel assessment (CCA) procedure, including sensing a channel to determine whether the channel is occupied (e.g., used by other communication devices) or unoccupied (e.g., unused by other communication devices) prior to performing wireless communication (e.g., downlink communication, uplink communication, sidelink communication) on the channel. In some wireless communications system, a reconfigurable intelligent surface (RIS) device may be deployed for communicating (e.g., transmitting, receiving, reflecting, etc.) wireless communication (e.g., control information, data, signals, packets, and the like) between communication devices (e.g., a base station and a UE) in the wireless communications system.

### SUMMARY

According to an aspect of the present disclosure, there is provided a method performed by a network unit, the method comprising: transmitting, to a reconfigurable intelligent surface (RIS) device, a first configuration message comprising a first mapping of each of one or more sensing beams of a set of sensing beams associated with the network unit to each of one or more sensing beams of a set of sensing beams associated with the RIS device; and performing a channel access procedure for each of the one or more sensing beams of the set of sensing beams associated with the network unit, wherein the channel access procedure is performed in parallel with the RIS device based at least in part on the first configuration message.

According to another aspect of the present disclosure, there is provided a network unit comprising: a transmitter; and a processor, wherein the processor is configured to: transmit, via the transmitter, a first configuration message to a reconfigurable intelligent surface (RIS) device, the first configuration message comprising a first mapping of each of one or more sensing beams of a set of sensing beams associated with the network unit to each of one or more sensing beams of a set of sensing beams associated with the RIS device; and perform a channel access procedure for each of the one or more sensing beams of the set of sensing beams associated with the network unit, wherein the channel access procedure is performed in parallel with the RIS device based at least in part on the first configuration message.

According to another aspect of the present disclosure, there is provided a method performed by a reconfigurable intelligent surface (RIS) device, the method comprising: receiving a first configuration message from a network unit, the first configuration message comprising a first mapping of each of one or more sensing beams of a set of sensing beams associated with the network unit to each of one or more sensing beams of a set of sensing beams associated with the RIS device; and configuring a plurality of elements of the RIS device based on the first configuration message during a channel access procedure performed by the network unit.

According to another aspect of the present disclosure, there is provided a reconfigurable intelligent surface (RIS) device, the RIS device comprising: a receiver; a plurality of elements; and a processor, wherein the processor is configured to receive, via the receiver, a first configuration message from a network unit, the first configuration message comprising a first mapping of each of one or more sensing beams of a set of sensing beams associated with the network unit to each of one or more sensing beams of a set of sensing beams associated with the RIS device; and configure the plurality of elements based on the first configuration message during a channel access procedure performed by the network unit.

Other aspects are set out in the appended claims.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 illustrates a wireless communication system that supports a channel access procedure for wireless communication over a shared spectrum in accordance with aspects of the present disclosure;

FIG. 2 is a schematic block diagram of a remote unit that supports a channel access procedure for wireless communication over a shared spectrum in accordance with aspects of the present disclosure;

FIG. 3A is a schematic block diagram of a network unit that supports a channel access procedure for wireless communication over a shared spectrum in accordance with aspects of the present disclosure;

FIG. 3B is a schematic block diagram of a RIS device that supports a channel access procedure for wireless communication over a shared spectrum in accordance with aspects of the present disclosure;

FIG. 4A is a flowchart illustrating a method performed by a network unit that supports a channel access procedure for wireless communication over a shared spectrum in accordance with aspects of the present disclosure;

FIG. 4B is a flowchart illustrating a method performed by a RIS device that supports a channel access procedure for wireless communication over a shared spectrum in accordance with aspects of the present disclosure;

FIG. 5 illustrates mapping of a sensing beam associated with a network unit to one or more sensing beams of a set of sensing beams associated with a RIS device;

FIG. 6 illustrates using a wide sensing beam at a RIS device;

FIG. 7 illustrates mapping of a transmission beam associated with a network unit to one or more transmission beams associated with a RIS device; and

FIG. 8 illustrates sharing multiple channel occupancy times with a RIS device for multi LBT.

### DETAILED DESCRIPTION

In 3GPP 5G New Radio (NR-U), channel access in both downlink and uplink rely on the LBT procedure. The gNB and/or UE first senses the channel to find out there is no on-going communications prior to any transmission. When a communication channel is a wide bandwidth unlicensed carrier, the clear channel assessment (CCA) procedure relies on detecting the energy level on multiple sub-bands of the communications channel. No beamforming is considered for LBT in NR-U in Rel. 16 and only omni-directional LBT is assumed.

In Rel. 17, when a gNB is required by regulations to sense a channel(s) for availability for performing transmission(s) on the channel(s) or when a gNB provides UE(s) with higher layer parameters channelAccessMode2-r17 by SIB1 or dedicated configuration indicating that the channel access procedures would be performed by UE before transmission(s) on a channel(s), channel access procedures outlined below for accessing the channel(s) on which the transmission(s) are performed by the gNB/UE(s), are applied.

When a gNB/UE senses a channel for availability to perform downlink (DL)/uplink (UL) transmission(s), the channel for sensing includes at least the corresponding active DL/UL bandwidth part(s) for the DL/UL transmission(s).

When sensing is applicable, the basic unit to perform sensing is a sensing slot with a duration Tₛₗ=5 μs. The channel is considered to be idle for the sensing slot duration Tₛₗ if a gNB or a UE senses the channel during the sensing slot duration and determines that the detected energy after the antenna assembly within the sensing slot duration is less than energy detection threshold X_{Thresh}. Otherwise, the channel is considered busy for the sensing slot duration Tₛₗ.

A maximum gap among a set of DL or UL transmissions in a DL or UL transmission burst, respectively, is 8 μs. For determining a Channel Occupancy Time, if a transmission gap is less than or equal to 8 μs, the gap duration is counted in the channel occupancy time.

The spatial domain filter for sensing beam(s) during the sensing slot duration at the gNB, or at a UE when the UE does not indicate a capability for beam correspondence without the uplink beam sweeping, or at a UE when the UE uses a different beam for sensing than the beam used for transmission, covers the transmission beam(s) of the intended transmission(s) within the channel occupancy.

If a UE indicates a capability for beam correspondence without the uplink beam sweeping and if the UE selects the same sensing beam(s) as the transmission beam(s), the spatial domain filter for sensing beam is determined accordingly.

If a channel occupancy includes transmission(s) in different beams that are multiplexed in spatial domain, one of the followings is applicable for the corresponding sensing to perform the transmission(s) within the channel occupancy:
Type 1 channel access procedure is applied before the start of the channel occupancy using a single sensing beam where the single beam covers all the transmission beams within the channel occupancy. When the channel is accessed, the transmission(s) within the channel occupancy across different beams can occur.
Type 1 channel access procedure is applied before the start of the channel occupancy simultaneously per sensing beam where each sensing beam covers a transmission beam within the channel occupancy. When the channel is accessed, the transmission(s) within the channel occupancy across different beams can occur.

If a channel occupancy includes transmissions in different beams that are multiplexed in time domain, one of the followings is applicable for the corresponding sensing to perform the transmissions within the channel occupancy:
Type 1 channel access procedure is applied before the start of the channel occupancy using a single sensing beam where the single beam covers all the transmissions beams within the channel occupancy. When the channel is accessed, the transmissions within the channel occupancy across different beams can occur.
When the gNB/UE can perform simultaneous sensing in different beams, Type 1 channel access procedure is applied before the start of the channel occupancy per sensing beam where each sensing beam covers a transmission beam within the channel occupancy. When the channel is accessed, the transmission within the channel occupancy across different beams can occur.
When the gNB/UE can perform simultaneous sensing in different beams, Type 1 channel access procedure is applied before the start of the channel occupancy per sensing beam where each sensing beam covers a transmission beam within the channel occupancy. When the channel is accessed, the transmission within the channel occupancy can occur before switching to a different beam within the channel occupancy.

When the gNB intends to transmit a DL transmission(s) across multiple transmission beams, if the gNB performs sensing on the corresponding sensing beam(s) independently, the DL transmission(s) can occur on a transmission beam(s) among the multiple transmission beams if the channel access procedures on the corresponding sensing beam(s) have succeeded, and the channel occupancy would start at the same time across the multiple transmission beams.

When a UE is scheduled by a DCI to transmit a UL transmission(s), the scheduling DCI may indicate the corresponding channel access procedures for the UL transmission(s). The UE determines based on the DCI if Type 1, or Type 2, or Type 3 channel access procedures, is applicable.

When a UE is scheduled with a set of consecutive UL transmissions, the following are applicable:
The UE is not expected to be indicated with different channel access types for any consecutive UL transmissions without gaps in between the transmissions.
If the UE cannot access the channel for a transmission in the set prior to the last transmission according to one of Type 1 or Type 2 channel access procedures, the UE shall attempt to transmit the next transmission according to the channel access type indicated in the corresponding UL grant or DL assignment.
If a UE is scheduled to transmit a set of consecutive UL transmissions without gaps including PUSCH using one or more UL grant(s), PUCCH using one or more DL grant(s), or SRS with one or more DL grant(s) or UL grant(s) and the UE transmits one of the scheduled UL transmissions in the set after accessing the channel according to one of Type 1, Type 2, or Type 3 channel access procedures, the UE may continue transmission of the remaining UL transmissions in the set, if any.

In this disclosure, we deal with the channel access mechanism in unlicensed band when a reconfigurable intelligent surface (RIS) device is deployed in the network. As beam-based operation is assumed for unlicensed spectrum in FR2 and beyond, listen before talk (LBT) is performed in a specific beam direction(s) at the gNB. In release 17 (Rel. 17), the gNB can share the channel occupancy time (COT) with the user equipment (UE) once the Category 4 (Cat 4) LBT is successful for a certain Tx beam/sensing beam from the gNB, such that the UE uses the configured UL Tx beams or the beam correspondence within the COT for its UL transmission without performing Cat 4 LBT.

The UE needs to perform Cat 2 LBT for its UL transmission in the shared COT if the gap is beyond 16/25 micro sec. However, when a RIS device is deployed in the network, the gNB would have very few backhaul beams with the RIS device to communicate with UEs in different directions, and the results of the directional LBT depends also on the status of a RIS reflection configuration in different time slots, not only on the direction LBT at gNB. During the COT shared by the gNB for that specific Tx beam at gNB, the RIS device may be configured previously with beam indexes to reflect the signal in different directions for different time domain resources (also referred to herein as “time resources”).

The present disclosure relates to configuring the RIS device to assist the LBT operation at the gNB. In particular, the network configures the RIS device to assist the LBT operation before the transmission of DL and/or UL. The RIS device is configured by the network with spatial information to perform reflection on UL and/or DL direction, where the spatial information contains reflection coefficients (phase values of the RIS elements) to beamform the signal in different directions associated with preconfigured time domain resources during a clear channel assessment operation (CCA) at the gNB.

Some embodiments of the present disclosure relate to sharing the COT initiated by the gNB with the RIS device for DL transmission.

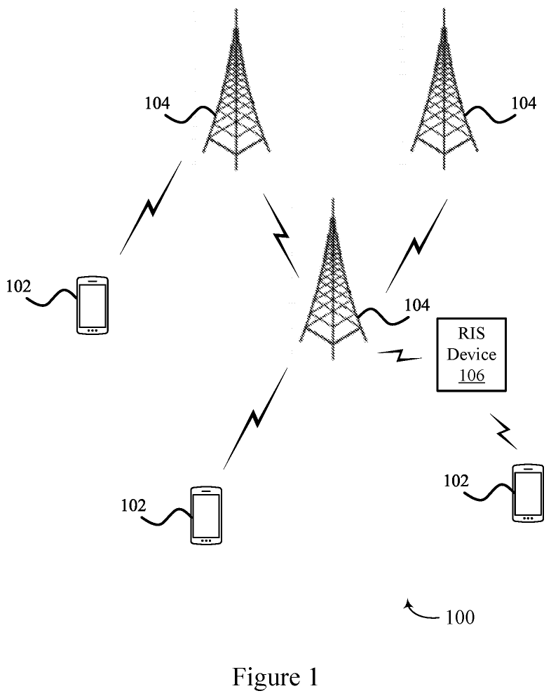

FIG. 1 depicts an embodiment of a wireless communication system. In one embodiment, the wireless communication system 100 includes remote units 102, network units 104, and RIS devices 106. Even though a specific number of remote units 102, network units 104, and RIS devices 106 are depicted in FIG. 1, one of skill in the art will recognize that any number of remote units 102, network units 104, and RIS devices 106 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNodeB (“gNB”) , a Home Node-B, a RAN, a relay node, a device, a network device, an integrated and access backhaul (“IAB”) node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the third generation partnership program (“3GPP”) protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit downlink (“DL”) communication signals to serve the remote units 102 in the time, frequency, and/or spatial domain.

The RIS devices 106 may be any suitable reconfigurable intelligent surface, such as a smart surface (“SS”), a large intelligent surface (“LIS”), an intelligent reflecting surface (“IRS”), and so forth. A reconfigurable intelligent surface may mean a device having one or more elements (e.g., programmable elements) that are configured to reflect a signal in a manner that the signal is boosted upon reflection.

The network units 104 may communicate with the remote units 102 by transmissions transmitted toward RIS devices 106, with the RIS devices 106 reflecting and boosting the received transmissions that are directed toward the remote units 102. Furthermore, the remote units 102 may communicate with the network units 104 by transmissions transmitted toward RIS devices 106, with the RIS devices 106 reflecting and boosting the received transmissions that are directed toward the network units 104. As may be appreciated, the RIS devices 106 may receive transmissions comprising control signals from one or more network units 104 to control its configuration.

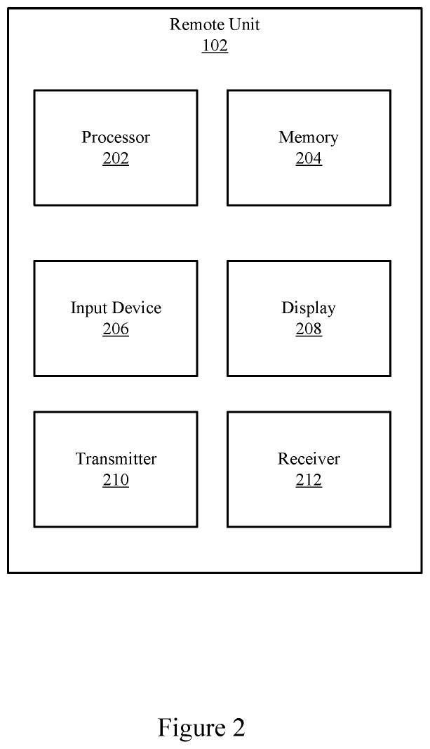

FIG. 2 is a schematic block diagram of a remote unit 102. As shown, the remote unit 102 may include a processor 202, a memory 204, an input device 206, a display 208, a transmitter 210, and a receiver 212. The input device 206 and the display 208 may be combined into a single device, such as a touchscreen. The remote unit 102 may not include any input device 206 and/or display 208.

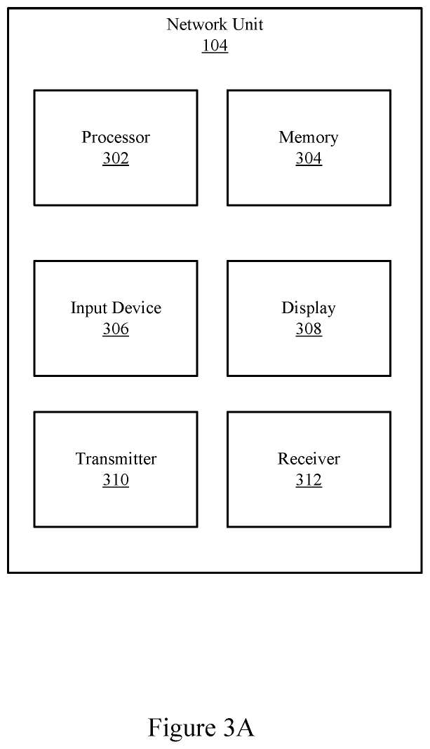

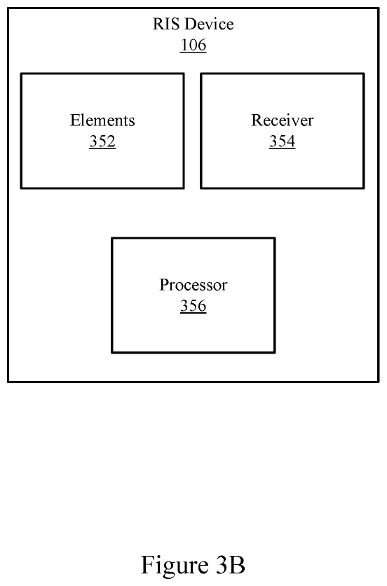

FIG. 3A is a schematic block diagram of a network unit 104. The network unit 104 may include a processor 302, a memory 304, an input device 306, a display 308, a transmitter 310, and a receiver 312. The remote unit 102 may not include any input device 306 and/or display 308.

The processor 302, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 302 executes instructions stored in the memory 204 to perform the methods and routines described herein. The processor 302 is communicatively coupled to the memory 304, the input device 306, the display 308, the transmitter 310, and the receiver 312.

The memory 304, in one embodiment, is a computer readable storage medium. In some embodiments, the memory 304 includes volatile computer storage media. For example, the memory 304 may include a RAM, including dynamic RAM (“DRAM”), synchronous dynamic RAM (“SDRAM”), and/or static RAM (“SRAM”). In some embodiments, the memory 304 includes non-volatile computer storage media. For example, the memory 304 may include a hard disk drive, a flash memory, or any other suitable non-volatile computer storage device. In some embodiments, the memory 304 includes both volatile and non-volatile computer storage media. In some embodiments, the memory 304 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 306 may be integrated with the display 208, for example, as a touchscreen or similar touch-sensitive display. In some embodiments, the input device 306 includes a touchscreen such that text may be input using a virtual keyboard displayed on the touchscreen and/or by handwriting on the touchscreen. In some embodiments, the input device 306 includes two or more different devices, such as a keyboard and a touch panel.

The display 308, in one embodiment, may include any known electronically controllable display or display device. The display 308 may be designed to output visual, audible, and/or haptic signals. In some embodiments, the display 308 includes an electronic display capable of outputting visual data to a user. For example, the display 308 may include, but is not limited to, a liquid crystal display (“LCD”) display, an LED display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 308 may be a component of a smart phone, a personal digital assistant, a television, a table computer, a notebook (laptop) computer, a personal computer, a vehicle dashboard, or the like.

In certain embodiments, the display 308 includes one or more speakers for producing sound. For example, the display 308 may produce an audible alert or notification (e.g., a beep or chime). In some embodiments, the display 308 includes one or more haptic devices for producing vibrations, motion, or other haptic feedback. In some embodiments, all or portions of the display 308 may be integrated with the input device 306. For example, the input device 306 and display 308 may form a touchscreen or similar touch-sensitive display. In other embodiments, the display 308 may be located near the input device 306.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

The network unit 104 may be associated with a set of sensing beams. In particular, the transmitter 310 may be associated with the set of sensing beams. The set of sensing beams may comprise one or more sensing beams. A sensing beam associated with the network unit 104 is a beam used to receive a signal (e.g. any signal transmitted from other devices not connected to the network unit 104, like WiFi) and is used to perform channel access procedures (e.g. CCA procedures).

FIG. 3B is a schematic block diagram illustrating a reconfigurable intelligent surface (“RIS”) device 106. The RIS device 106 may include elements 352, a receiver 354, and a processor 356. As may be appreciated, in some embodiments, the processor 356 and the receiver 354 may be substantially similar to the processor 302 and the receiver 312 of the network unit 104, respectively. In various embodiments, the elements 352 include one or more programmable and/or controllable elements. A number of elements 352 may be at least one hundred, at least one thousand, many thousands, and so forth. In certain embodiments, each of the elements 352 may be individually programmed and/or controlled by properties to facilitate reflecting and boosting transmissions that are directed toward a corresponding element. In various embodiments, two or more elements 352 may be grouped together into one or more groups of elements. In such embodiments, the one or more groups of elements may be individually programmed and/or controlled by properties to facilitate reflecting and boosting transmissions that are directed toward elements of the corresponding group. A set of elements 352 referred to herein may include one or more elements. The receiver 354 may be any suitable wireless or wired receiver configured to receive control signals for programming and/or controlling the elements 352. The processor 356 may be any suitable hardware and/or software device that can receive the control signals for programming and/or controlling the elements 352 and provide information to the elements 352 for controlling and/or programming the elements.

In some embodiments, the RIS device 106 may have a planar 2-dimensional array of metaatoms (e.g., unit cell, elements) in which each passive element (or group of elements) may be set to one of several states with different reflecting coefficients. Together, the metaatoms give the RIS a macro-property to manipulate an impinge electromagnetic (“EM”) wave and divert it in a direction of an intended receiver. This may improve the performance at the receiver and/or reduce interference to other users.

The RIS device 106 may be associated with a set of sensing beams. The set of sensing beams may comprise one or more sensing beams. Each of the one or more sensing beams used by the RIS device 106 is associated with a configuration of phases of the elements 352. In particular, each sensing beam of the RIS device 106 may correspond to a codebook representing phase coefficients of the elements 352. A sensing beam associated with the RIS device 106 is a beam used to receive a signal which is then reflected by the elements 352 to the network unit 104.

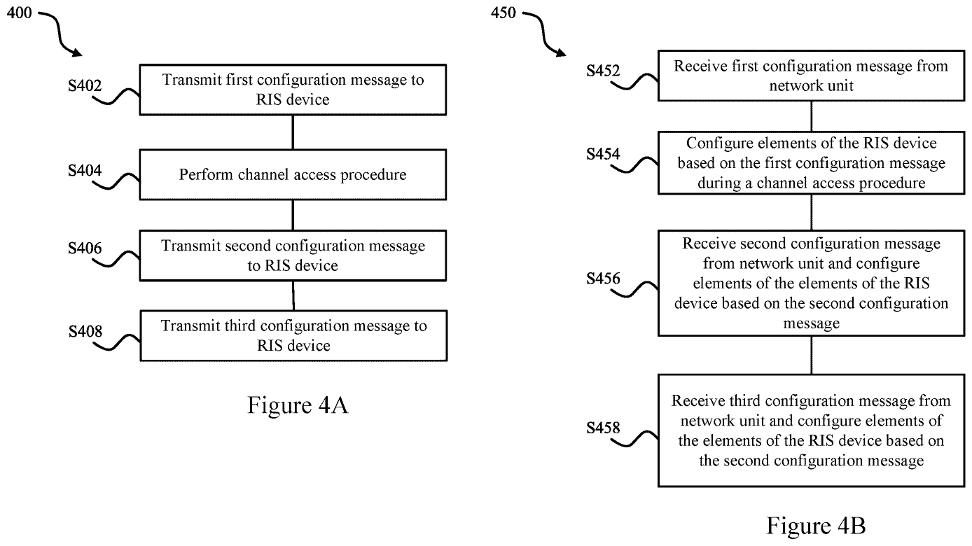

FIG. 4A is a flowchart illustrating a method 400 performed by the network unit 104. Embodiments are described below with reference to the network unit 104 being a “gNB”, however as described above embodiments are not limited to any particular radio access technology.

In method 400, at step S402, the processor 302 transmits, via the transmitter, a first configuration message to the RIS device 106. The first configuration message comprising a first mapping of each of one or more sensing beams of a set of sensing beams associated with the network unit 104 to each of one or more sensing beams of a set of sensing beams associated with the RIS device 106.

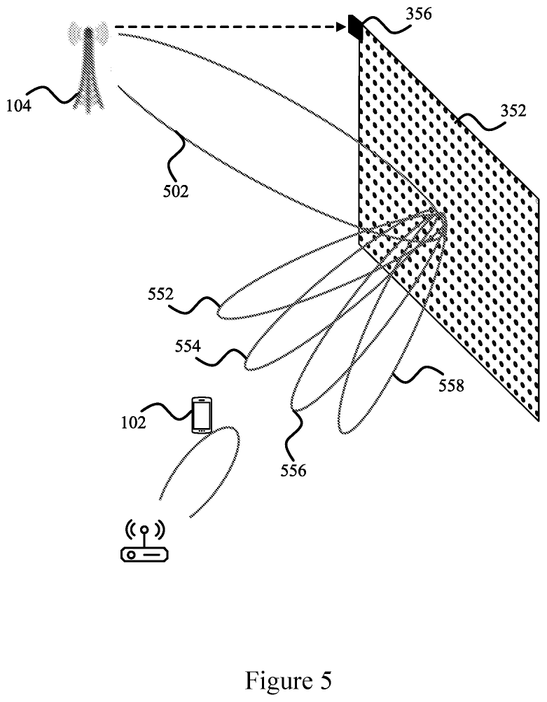

FIG. 5 illustrates a sensing beam 502 associated with the network unit 104. As shown in FIG. 5, the sensing beam 502 is directed towards elements of the RIS device 106. FIG. 5 further illustrates a set of sensing beams associated with the RIS device 106 comprising a first RIS sensing beam 552, a second RIS sensing beam 554, a third RIS sensing beam 556, and a fourth RIS sensing beam 558. Each of the set of sensing beams associated with the RIS device 106 corresponds to a codebook representing phase coefficients of elements 352. It will be appreciated that the number of sensing beams shown in FIG. 5 is merely an example.

The first configuration message configures the RIS device 106 to apply one or more specific sensing beams at the RIS device 106 during a channel access procedure performed by the network unit 104.

In example implementations, the RIS device 106 has access to a preconfigured table in which the sensing beam 502 at the gNB side can be mapped to one or more of a plurality of sensing beams associated with the RIS device 106. The preconfigured table may be stored in memory accessible to the RIS device 106. The RIS device 106 may comprise the memory storing the preconfigured table. Alternatively, the preconfigured table may be stored in a memory of an external device. The preconfigured table may contain sensing beam indices of the gNB mapped to a plurality of sensing beam indices at the RIS side.

For example, the preconfigured table may specify that: at time domain resource T1, when the gNB is using sensing beam 502 for CCA the RIS device 106 should configure elements 352 to apply sensing beam 552; at time domain resource T2, when the gNB is using sensing beam 502 for CCA the RIS device 106 should configure elements 352 to apply sensing beam 554; at time domain resource T3, when the gNB is using sensing beam 502 for CCA the RIS device 106 should configure elements 352 to apply sensing beam 556; and at time domain resource T4, when the gNB is using sensing beam 502 for CCA the RIS device 106 should configure elements 352 to apply sensing beam 558.

In these example implementations, the first configuration message may comprise at least one row index, each of the at least one index corresponding to a row in the preconfigured table comprising a time resource, a sensing beam of the set of sensing beams associated with the network unit, and one or more sensing beams of the set of sensing beams associated with the RIS device to be used by the RIS device at the time resource. In these example implementations, it is the preconfigured table which stores for each time resource: (i) a RIS sensing beam index corresponding to phase coefficients of elements 352 to be applied by the RIS device 106 to produce the one or more sensing beams of the set of sensing beams associated with the RIS device; and (ii) a gNB sensing beam index corresponding to phase coefficients of elements 352 to be applied by the RIS device 106 to produce a reflection beam corresponding to the sensing beam of the set of sensing beams associated with the network unit.

One or more of the time resources may be associated with a single sensing beam of the set of sensing beams associated with the RIS device. One or more of the time resources may be associated with a plurality of sensing beams of the set of sensing beams associated with the RIS device. A plurality of sensing beams to be applied by the RIS device in a single time resource may be applied using different elements 352 of the RIS device.

The sensing beam(s) to be applied by the RIS device in a first time resource, may be different to the sensing beam(s) to be applied by the RIS device in a second later time resource. The elements 352 used to apply the sensing beam(s) in the first time resource may be the same as those used to apply the sensing beam(s) in the second time resource. Alternatively, the elements 352 used to apply the sensing beam(s) in the first time resource may be different to those used to apply the sensing beam(s) in the second time resource.

In other implementations, the RIS device 106 does not have access to such a preconfigured table, and the first configuration message comprises the one or more time resources, and for each of the one or more time resources a sensing beam of the set of sensing beams associated with network unit, and the one or more sensing beams of the set of sensing beams associated with the RIS device to be applied at the time resource. In particular, the first configuration message may comprise for each time resource: (i) a RIS sensing beam index corresponding to phase coefficients of elements 352 to be applied by the RIS device 106 to produce the one or more sensing beams of the set of sensing beams associated with the RIS device; and (ii) a gNB sensing beam index corresponding to phase coefficients of elements 352 to be applied by the RIS device 106 to produce a reflection beam corresponding to the sensing beam of the set of sensing beams associated with the network unit.

Thus, from the first configuration message the RIS device 106 knows which sensing beam to be used to receive a signal, which reflected beam to be used to reflect the signal to the gNB (sensing beam of the gNB), and at which time slot it needs to perform this.

A time resource can be a slot number or a symbol number in a slot. Since the RIS device 106 is synchronized to the network, the timing and slot/frame numbering used by the RIS device 106 are aligned with the gNB.

At step S404, the processor 302 performs a channel access procedure (e.g. a CCA procedure) for each of the one or more sensing beams of the set of sensing beams associated with the network unit, wherein the channel access procedure is performed in parallel with the RIS device based at least in part on the first configuration message.

Embodiments of the present disclosure ensure that whenever the channel access procedure is performed at the gNB, the channel access procedure is not performed in the perspective of the gNB but in the perspective of one or more sensing beams of the RIS device 106.

One example of a channel access procedure is a CCA procedure. A CCA procedure is a form of a listen-before-talk (LBT) procedure. A Listen-Before-Talk (LBT) procedure is an essential mechanism that allows radio communication systems to share an unlicensed band while maintaining the performance of each individual system. When using LBT, prior to a device transmitting a signal, the device listens to the channel to determine whether the channel is already occupied. Further references to the LBT procedure in the description relate to the CCA procedure.

In a CCA procedure, a device will “listen” for RF transmissions at the physical layer. A signal detect threshold and/or an energy detect threshold may be used to identify any transmissions from another device being transmitted on the to-be evaluated channel.

Thus when the CCA procedure for directional LBT is performed at gNB (e.g. using Cat 4 LBT), gNB may sense for channel occupancy jointly considering the sensing beam of gNB and RIS. Hence, for each clear channel assessment procedure for a fixed sensing beam at gNB, the sensing beam at the RIS side may be different in different time domain resources (which in some implementations is already preconfigured using a table).

As noted above a sensing beam applied at the RIS device 106 corresponds to a codebook representing phase coefficients of RIS elements (e.g. from a pre-defined table). The configured sensing beam applied at the RIS device 106 can be associated with a transmission beam for the UE 102 to receive its DL and/or transmit its UL after a successful CCA procedure for the sensing beam.

In embodiments of the present disclosure, the gNB configures the RIS device 106 with a set of sensing beams, where each beam corresponds to a codebook representing phase coefficients of RIS elements 352 (e.g. from a pre-defined table), and performs LBT on the backhaul beam(s) (sensing beam(s) at gNB), used to communicate with the RIS device 106 in multiple time domain resources (e.g. symbols/slots) where each time resource for performing LBT may be mapped to one sensing beam pair at both gNB and RIS. During performing LBT on the backhaul beam, based on the first configuration message, the RIS device 106 switches the Rx beam to the configured sensing beam for each time domain resource, so that a single sensing beam at gNB can be mapped to different sensing beams at the RIS device 106.

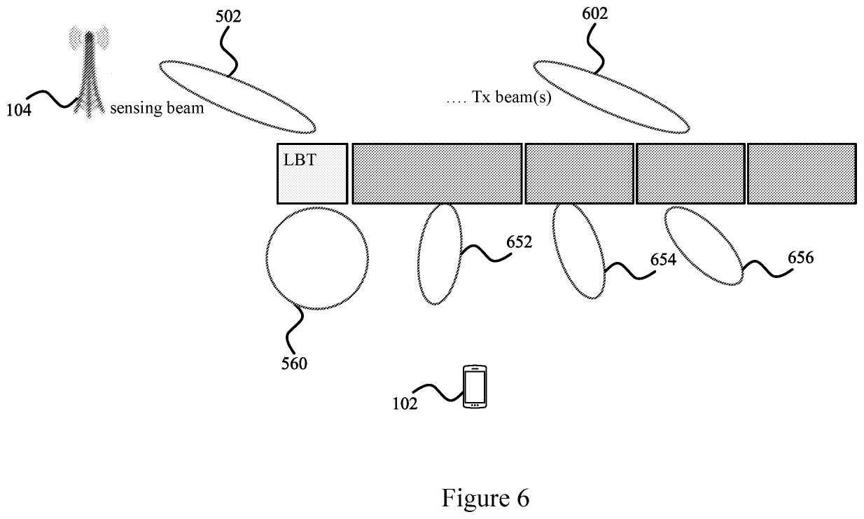

In an example implementation, the gNB performs a clear channel assessment (CCA) procedure on the backhaul sensing beam 502 and configures the RIS device 106 to use a wide sensing beam to cover a certain propagation space. This is illustrated in FIG. 6.

In particular, the first configuration message may comprise a mapping of a sensing beam 502 associated with the network unit 104 to a single sensing beam 560 which covers multiple potential transmission and/or reflection beams at the RIS device 106 (to cover a certain propagation space).

FIG. 4B is a flowchart illustrating a method 450 performed by the RIS device 106.

In method 450, at step S452 the RIS device 106 receives, via the receiver 354, the first configuration message from the network unit.

At step S452, the processor 356 receives, via the receiver 354, the first configuration message from the network unit 104.

At step S454, the processor 356 configures the plurality of elements based on the first configuration message during the channel access procedure performed by the network unit. That is, the gNB senses for channel occupancy during a CCA procedure jointly considering the sensing beam of gNB 502 and one or more sensing beams of the RIS device 106 in a particular time resource applied by the RIS device 106 in accordance with the first configuration message.

As noted above, in example implementations, the first configuration message may comprise at least one row index. In these example implementations, the processor 356 is configured to query the preconfigured table stored in memory with the at least one index to obtain an entry corresponding to each of the at least one index. These table entries indicate one or more sensing beams of the set of sensing beams associated with the RIS device to be output by the RIS device at one or more time resources corresponding to when the gNB senses for channel occupancy during a CCA procedure.

For each time resource, the processor 356 is configured to use the RIS sensing beam index to obtain the corresponding phase coefficients of elements 352 to be applied by the RIS device 106 to produce the one or more sensing beams of the set of sensing beams associated with the RIS device; and use the gNB sensing beam index to obtain the corresponding phase coefficients of elements 352 to be applied by the RIS device 106 to produce a reflection beam corresponding to the sensing beam of the set of sensing beams associated with the network unit. For example, the processor 356 may query a table stored in memory accessible to the RIS device 106, the table storing a mapping of beam indexes to coefficients (phase values of the RIS elements 352).

We now refer back to the method 400 illustrated in FIG. 4A.

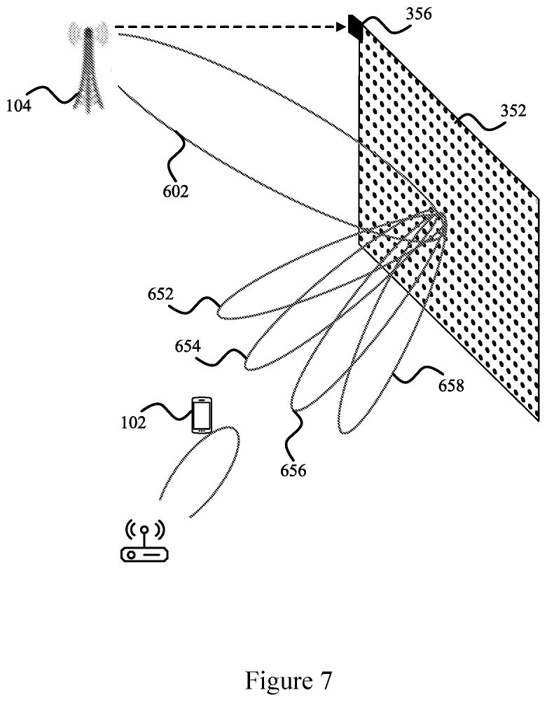

Upon a successful LBT (i.e. after a successful CCA procedure) at gNB for a sensing beam applied at the RIS device 106, the gNB may transmit its intended DL signal and configure the RIS device 106. A transmission beam 602 associated with the network unit 104 is shown in FIGS. 6 and 7. As shown in FIG. 7, the transmission beam 602 is directed towards elements 352 of the RIS device 106.

It will be appreciated that the gNB can use a spatial filter to receive, and another spatial filter to transmit. Therefore, mapping between the sensing beam 502 and transmission beam 602 may be needed. Similarly, if the sensing beam 502 is wide it can be associated with one of multiple transmission beams within the sensing beam 502.

At step S406, the network unit 104 configures the RIS device 106. In particular, the processor 302 is configured to transmit, via the transmitter 310, a second configuration message to the RIS device 106. The second configuration message comprises a second mapping of each of the one or more sensing beams of the set of sensing beams associated with the RIS device with each of one or more transmission beams associated with the RIS device.

In particular, the second configuration message configures the RIS device 106 to use a transmission beam corresponding to the sensing beam used for performing the successful LBT. For example, if a CCA procedure was successful in a time resource in which the RIS device 106 applied the first RIS sensing beam 552, the second configuration message configures the RIS device 106 to use a transmission beam 652 corresponding to the first RIS sensing beam 552. If a CCA procedure was successful in a time resource in which the RIS device 106 applied the second RIS sensing beam 554, the second configuration message configures the RIS device 106 to use a transmission beam 654 corresponding to the second RIS sensing beam 554. If a CCA procedure was successful in a time resource in which the RIS device 106 applied the third RIS sensing beam 556, the second configuration message configures the RIS device 106 to use a transmission beam 656 corresponding to the third RIS sensing beam 556. If a CCA procedure was successful in a time resource in which the RIS device 106 applied the fourth RIS sensing beam 558, the second configuration message configures the RIS device 106 to use a transmission beam 658 corresponding to the fourth RIS sensing beam 558.

If the RIS device 106 was configured with a wide sensing beam 560 during LBT (see FIG. 6), the wide sensing beam 560 can be associated with any transmission beam reflected from the RIS device 106 within the wide sensing beam 560. For example, if the wide sensing beam 560 covered all of the first RIS sensing beam 552, the second RIS sensing beam 554, the third RIS sensing beam 556, and the fourth RIS sensing beam 558, the wide sensing beam 560 can be associated with a transmission beam corresponding to any of the RIS sensing beams 552, 554, 556, 558.

In some implementations, the mapping between the sensing beam and the transmission beam at the RIS device 106 is valid for both UL and DL, e.g., by utilizing beam correspondence between UL and DL. In other implementations, the mapping between the sensing beam and the transmission beam at the RIS device 106 is valid for DL only (transmission from the gNB to the UE using reflection from the RIS device) and another mapping for UL is used based on LBT operation at the UE.

Upon a failed LBT, the gNB may configure the RIS with a different sensing beam and performs LBT on the backhaul beam (sensing beam 502 at gNB), where the configured sensing beam at the RIS device can be associated with one of the configured transmission beams for the UE to transmit its UL and/or receive its DL. The gNB may send to the RIS device 106 a deactivation command of any previously configured periodic or semi-static transmission on the beam associated with the failed LBT.

In the method 450 performed by the RIS device 106, at step S456 the RIS device 106 may receive, via the receiver 354, the second configuration message from the network unit 104.

At step S456, the processor 356 configures the plurality of elements based on the second configuration message. Following completion of step S456, a DL signal sent from the network unit 104 using the transmission beam 602 associated with the network unit 104 will be reflected by the RIS device 106 using a transmission beam applied at the RIS device 106 which corresponds to a sensing beam used in the successful CCA procedure.

We now refer back to the method 400 illustrated in FIG. 4A.

Upon a successful LBT (i.e. after a successful CCA procedure) at gNB in one or more-time resources, at step S408 the processor 302 may transmit, via the transmitter 310, a third configuration message to the RIS device 106. The third configuration message comprises an indication of one or more channel occupancy times (COTs) to share with the RIS device 106 and one or more time resources associated with the one or more COTs based at least in part on the performed channel access procedure.

In particular, the gNB initiates and shares a COT with the RIS device 106 along with the associated time resource(s) such that RIS device 106 uses the corresponding beam pair for UL and/or DL reflection within the shared COT. Before performing reflection, the RIS device 106 maps the time domain resources where the DL was received and looks up in the mapping table to determine the corresponding transmission beams/reflected beams to be used within the COT.

In some implementations, the gNB shares the COT with the RIS device 106 along with a set of the time domain resources associated with the successful LBT.

In other implementations, the gNB shares the COT with the RIS device 106 along with the time resources associated with the failed LBT such that the RIS device 106 restricts the reflection on the beams associated with these time domain resources within the shared COT.

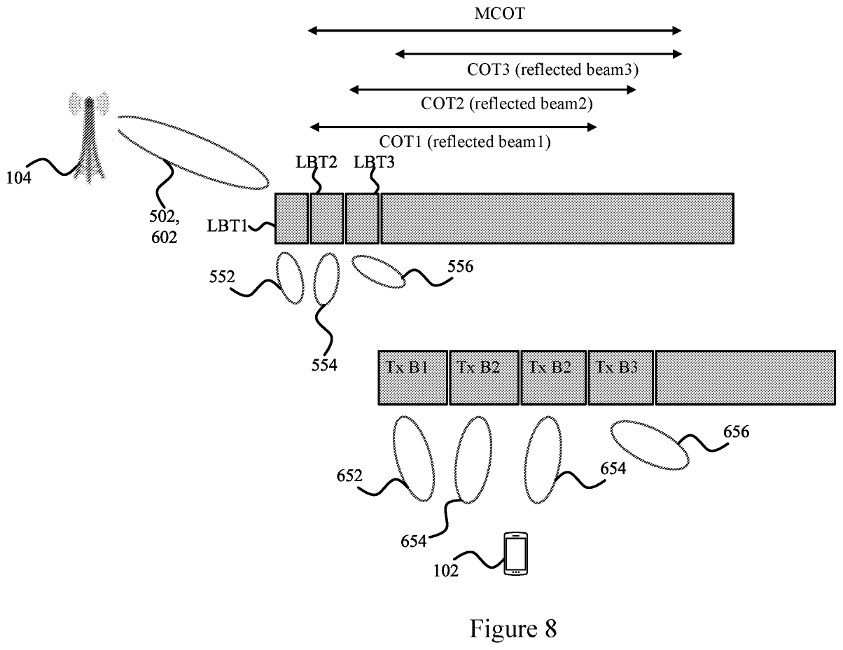

In yet further implementations, the third configuration message comprises a plurality of channel occupancy times and a time resource associated with each of the plurality of channel occupancy times, each of the plurality of channel occupancy times within a maximum channel occupancy time duration. In particular, the gNB initiates and shares multiple COTs with maximum COT duration (MCOT), each after a successful LBT on the corresponding time domain resource associated with different sensing beams at the RIS device 106 as shown in FIG. 8.

As shown in FIG. 8, if a CCA procedure was successful in a first time resource in which the RIS device 106 applied the first RIS sensing beam 552, the third configuration message comprises the first time resource and a first COT (COT1). This third configuration message causes the RIS device 106 to determine a transmission beam 652 corresponding to the first time resource, and use the transmission beam 652 within COT1.

If a CCA procedure was successful in a second time resource in which the RIS device 106 applied the second RIS sensing beam 554, the third configuration message comprises the second time resource and a second COT (COT2). This third configuration message causes the RIS device 106 to determine a transmission beam 654 corresponding to the second time resource, and use the transmission beam 654 within COT2.

If a CCA procedure was successful in a third time resource in which the RIS device 106 applied the third RIS sensing beam 556, the third configuration message comprises the third time resource and a third COT (COT3). This third configuration message causes the RIS device 106 to determine a transmission beam 656 corresponding to the third time resource, and use the transmission beam 656 within COT3.

In the method 450 performed by the RIS device 106, at step S458 the RIS device 106 may receive, via the receiver 354, the third configuration message from the network unit 104.

At step S458, the processor 356 configures the plurality of elements based on the third configuration message as described above.

If the RIS device 106 uses multiple elements 352 for reflecting the signal, the gNB may configure the RIS device 106 with simultaneous sensing beams to be applied for multiple elements 352 and performs LBT on the backhaul beam 502. Upon successful LBT, the gNB may share the COT with RIS device 106, so that the RIS is allowed to immediately reflect the signal during the actual transmission using the configured beams within the COT. Once the COT is initiated, the gNB/RIS can access other RIS beams during the COT without performing LBT.

Upon a failed LBT, the gNB may perform time division multiplexing (TDM) LBT on the backhaul beam and configure the RIS device 106 to switch the sensing beam for each time domain resource from each segment to identify the beam pair associated with the failed LBT.

We describe herein a new procedure to configure and share channel access procedure (e.g. LBT) results with a RIS device for assisting the communication in the unlicensed band. The procedure may include configuration of the RIS device with sensing beams to be switched during the LBT operation at the gNB. The procedure may include sharing a COT with the RIS device to perform reflection/transmission on the RIS sensing beams associated with a successful LBT.

As noted above, according to an aspect of the present disclosure, there is provided a method performed by a network unit, the method comprising: transmitting, to a reconfigurable intelligent surface (RIS) device, a first configuration message comprising a first mapping of each of one or more sensing beams of a set of sensing beams associated with the network unit to each of one or more sensing beams of a set of sensing beams associated with the RIS device; and performing a channel access procedure for each of the one or more sensing beams of the set of sensing beams associated with the network unit, wherein the channel access procedure is performed in parallel with the RIS device based at least in part on the first configuration message.

The first mapping may comprise, for each of the one or more sensing beams of the set of sensing beams associated with the network unit, one or more time resources, each of the one or more time resources associated with one or more sensing beams of the set of sensing beams associated with the RIS device.

The method first mapping may comprise at least one index, each of the at least one index corresponding to an entry in a preconfigured table stored in a memory accessible to the RIS device, the entry comprising a time resource of one or more time resources, and one or more sensing beams of the set of sensing beams associated with the RIS device to be output by the RIS device at the time resource.

Each time resource of the one or more time resources may be associated with a respective one or more sensing beams of the set of sensing beams associated with the RIS device.

A time resource of the one or more time resources may be associated with a plurality of sensing beams associated with the RIS device, the plurality of sensing beams applied on different elements of the RIS device.

A time resource of the one or more time resources may be associated with one or more sensing beams of the set of sensing beams associated with the RIS device applied by a first set of elements of the RIS device; and a further time resource of the one or more time resources may be associated with one or more sensing beams of the set of sensing beams associated with the RIS device applied by a second set of elements of the RIS device, the second set of elements different to the first set of elements.

The first mapping may comprise a mapping of a sensing beam of the set of sensing beams associated with the network unit to a single sensing beam which covers multiple potential transmission and/or reflection beams at the RIS device.

If the channel access procedure is successful, the method may further comprise transmitting a second configuration message to the RIS device, the second configuration message comprising a second mapping of each of the one or more sensing beams of the set of sensing beams associated with the RIS device with each of one or more transmission beams associated with the RIS device.

The second mapping may configure the RIS device for both uplink and downlink transmissions between the RIS device and a user equipment.

The second mapping may configure the RIS device for only downlink transmissions between the RIS device and a user equipment.

If the channel access procedure is successful, the method may further comprise transmitting a third configuration message to the RIS device, the third configuration message comprising an indication of one or more channel occupancy times to share with the RIS device and one or more time resources associated with the one or more channel occupancy times based at least in part on the performed channel access procedure.

The channel access procedure may have been successful in the one or more time resources.

The third configuration message may comprise a plurality of channel occupancy times and a time resource associated with each of the plurality of channel occupancy times, each of the plurality of channel occupancy times within a maximum channel occupancy time duration.

As noted above, according to an aspect of the present disclosure, there is provided a network unit comprising: a transmitter; and a processor, wherein the processor is configured to: transmit, via the transmitter, a first configuration message to a reconfigurable intelligent surface (RIS) device, the first configuration message comprising a first mapping of each of one or more sensing beams of a set of sensing beams associated with the network unit to each of one or more sensing beams of a set of sensing beams associated with the RIS device; and perform a channel access procedure for each of the one or more sensing beams of the set of sensing beams associated with the network unit, wherein the channel access procedure is performed in parallel with the RIS device based at least in part on the first configuration message.

The first mapping may comprise, for each of the one or more sensing beams of the set of sensing beams associated with the network unit, one or more time resources, each of the one or more time resources associated with one or more sensing beams of the set of sensing beams associated with the RIS device.

The first mapping may comprise at least one index, each of the at least one index corresponding to an entry in a preconfigured table stored in a memory accessible to the RIS device, the entry comprising a time resource of one or more time resources, and one or more sensing beams of the set of sensing beams associated with the RIS device to be output by the RIS device at the time resource.

Each time resource of the one or more time resources may be associated with a respective one or more sensing beams of the set of sensing beams associated with the RIS device.

A time resource of the one or more time resources may be associated with a plurality of sensing beams associated with the RIS device, the plurality of sensing beams applied on different elements of the RIS device.

A time resource of the one or more time resources may be associated with one or more sensing beams of the set of sensing beams associated with the RIS device applied by a first set of elements of the RIS device; and a further time resource of the one or more time resources may be associated with one or more sensing beams of the set of sensing beams associated with the RIS device applied by a second set of elements of the RIS device, the second set of elements different to the first set of elements.

The first mapping may comprise a mapping of a sensing beam of the set of sensing beams associated with the network unit to a single sensing beam which covers multiple potential transmission and/or reflection beams at the RIS device.

If the channel access procedure is successful, the processor may be further configured to transmit, via the transmitter, a second configuration message to the RIS device, the second configuration message comprising a second mapping of each of the one or more sensing beams of the set of sensing beams associated with the RIS device with each of one or more transmission beams associated with the RIS device.

The second mapping may configure the RIS device for both uplink and downlink transmissions between the RIS device and a user equipment.

The second mapping may configure the RIS device for only downlink transmissions between the RIS device and a user equipment.

If the channel access procedure is successful, the processor may be further configured to transmit, via the transmitter, a third configuration message to the RIS device, the third configuration message comprising an indication of one or more channel occupancy times to share with the RIS device and one or more time resources associated with the one or more channel occupancy times based at least in part on the performed channel access procedure.

The channel access procedure may have been successful in the one or more time resources.

The third configuration message may comprise a plurality of channel occupancy times and a time resource associated with each of the plurality of channel occupancy times, each of the plurality of channel occupancy times within a maximum channel occupancy time duration.

As noted above, according to an aspect of the present disclosure, there is provided a method performed by a reconfigurable intelligent surface (RIS) device, the method comprising: receiving a first configuration message from a network unit, the first configuration message comprising a first mapping of each of one or more sensing beams of a set of sensing beams associated with the network unit to each of one or more sensing beams of a set of sensing beams associated with the RIS device; and configuring a plurality of elements of the RIS device based on the first configuration message during a channel access procedure performed by the network unit.

The first mapping may comprise, for each of the one or more sensing beams of the set of sensing beams associated with the network unit, one or more time resources, each of the one or more time resources associated with one or more sensing beams of the set of sensing beams associated with the RIS device.

The first mapping may comprise at least one index, each of the at least one index corresponding to an entry in a preconfigured table stored in a memory accessible to the RIS device, the entry comprising a time resource of one or more time resources, and one or more sensing beams of the set of sensing beams associated with the RIS device to be output by the RIS device at the time resource.

The method may further comprise querying the preconfigured table with the at least one index to obtain the entry corresponding to each of the at least one index.

Each time resource of the one or more time resources may be associated with a respective one or more sensing beams of the set of sensing beams associated with the RIS device.

A time resource of the one or more time resources may be associated with a plurality of sensing beams associated with the RIS device, the plurality of sensing beams applied on different elements of the RIS device.

A time resource of the one or more time resources may be associated with one or more sensing beams of the set of sensing beams associated with the RIS device applied by a first set of elements of the RIS device; and a further time resource of the one or more time resources may be associated with one or more sensing beams of the set of sensing beams associated with the RIS device applied by a second set of elements of the RIS device, the second set of elements different to the first set of elements.

The first mapping may comprise a mapping of a sensing beam of the set of sensing beams associated with the network unit to a single sensing beam which covers multiple potential transmission and/or reflection beams at the RIS device.

If the channel access procedure is successful, the method may further comprise receiving a second configuration message from the network unit, the second configuration message comprising a second mapping of each of the one or more sensing beams of the set of sensing beams associated with the RIS device with each of one or more transmission beams associated with the RIS device; and configuring the plurality of elements of the RIS device based on the second configuration message.

The second mapping may configure the RIS device for both uplink and downlink transmissions between the RIS device and a user equipment.

The second mapping may configure the RIS device for only downlink transmissions between the RIS device and a user equipment.

If the channel access procedure is successful, the method may further comprise receiving a third configuration message from the network unit, the third configuration message comprising an indication of one or more channel occupancy times and one or more time resources associated with the one or more channel occupancy times based at least in part on the performed channel access procedure; and configuring the plurality of elements of the RIS device based on the third configuration message.

The channel access procedure may have been successful in the one or more time resources.

The third configuration message may comprise a plurality of channel occupancy times and a time resource associated with each of the plurality of channel occupancy times, each of the plurality of channel occupancy times within a maximum channel occupancy time duration.

As noted above, according to an aspect of the present disclosure, there is provided a reconfigurable intelligent surface (RIS) device, the RIS device comprising: a receiver; a plurality of elements; and a processor, wherein the processor is configured to receive, via the receiver, a first configuration message from a network unit, the first configuration message comprising a first mapping of each of one or more sensing beams of a set of sensing beams associated with the network unit to each of one or more sensing beams of a set of sensing beams associated with the RIS device; and configure the plurality of elements based on the first configuration message during a channel access procedure performed by the network unit.

The first mapping may comprise, for each of the one or more sensing beams of the set of sensing beams associated with the network unit, one or more time resources, each of the one or more time resources associated with one or more sensing beams of the set of sensing beams associated with the RIS device.

The first mapping may comprise at least one index, each of the at least one index corresponding to an entry in a preconfigured table stored in a memory accessible to the RIS device, the entry comprising a time resource of one or more time resources, and one or more sensing beams of the set of sensing beams associated with the RIS device to be output by the RIS device at the time resource.

The processor may be further configured to query the preconfigured table with the at least one index to obtain the entry corresponding to each of the at least one index.

Each time resource of the one or more time resources may be associated with a respective one or more sensing beams of the set of sensing beams associated with the RIS device.

A time resource of the one or more time resources may be associated with a plurality of sensing beams associated with the RIS device, the plurality of sensing beams applied on different elements of the RIS device.

A time resource of the one or more time resources may be associated with one or more sensing beams of the set of sensing beams associated with the RIS device applied by a first set of elements of the RIS device; and a further time resource of the one or more time resources may be associated with one or more sensing beams of the set of sensing beams associated with the RIS device applied by a second set of elements of the RIS device, the second set of elements different to the first set of elements.

The first mapping may comprise a mapping of a sensing beam of the set of sensing beams associated with the network unit to a single sensing beam which covers multiple potential transmission and/or reflection beams at the RIS device.

If the channel access procedure is successful, the processor may be further configured to: receive, via the receiver, a second configuration message from the network unit, the second configuration message comprising a second mapping of each of the one or more sensing beams of the set of sensing beams associated with the RIS device with each of one or more transmission beams associated with the RIS device; and configure the plurality of elements of the RIS device based on the second configuration message.

The second mapping may configure the RIS device for both uplink and downlink transmissions between the RIS device and a user equipment.

The second mapping configures the RIS device for only downlink transmissions between the RIS device and a user equipment.

If the channel access procedure is successful, the processor may be further configured to: receive, via the receiver, a third configuration message from the network unit, the third configuration message comprising an indication of one or more channel occupancy times and one or more time resources associated with the one or more channel occupancy times based at least in part on the performed channel access procedure; and configure the plurality of elements of the RIS device based on the third configuration message.

The channel access procedure may have been successful in the one or more time resources.

The third configuration message may comprise a plurality of channel occupancy times and a time resource associated with each of the plurality of channel occupancy times, each of the plurality of channel occupancy times within a maximum channel occupancy time duration.

It will be appreciated by the person of skill in the art that various modifications may be made to the above-described embodiments without departing from the scope of the present invention.

1. A method performed by a network unit, the method comprising:
transmitting a first configuration message comprising a first mapping of each of one or more sensing beams of a set of sensing beams associated with the network unit to each of one or more sensing beams of a set of sensing beams associated with a reconfigurable intelligent surface (RIS) device; and
performing a channel access procedure for each of the one or more sensing beams of the set of sensing beams associated with the network unit.

2. A network unit for wireless communication, network unit comprising:
at least one memory; and
at least one processor coupled with the at least one memory and configured to cause the network unit to:
transmit a first configuration message comprising a first mapping of each of one or more sensing beams of a set of sensing beams associated with the network unit to each of one or more sensing beams of a set of sensing beams associated with a reconfigurable intelligent surface (RIS) device; and
perform a channel access procedure for each of the one or more sensing beams of the set of sensing beams associated with the network unit.

3. The network unit of claim 2, wherein the first mapping comprises, for each of the one or more sensing beams of the set of sensing beams associated with the network unit, one or more time resources, wherein each of the one or more time resources is associated with one or more sensing beams of the set of sensing beams associated with the RIS device.

4. The network unit of claim 2, wherein the first mapping comprises at least one index, wherein each of the at least one index corresponds to an entry in a preconfigured table stored in a memory accessible to the RIS device, wherein the entry comprises a time resource of one or more time resources, and wherein one or more sensing beams of the set of sensing beams associated with the RIS device are to be output by the RIS device at the time resource.

5. The network unit of claim 3, wherein each time resource of the one or more time resources is associated with a respective one or more sensing beams of the set of sensing beams associated with the RIS device.

6. The network unit of claim 3, wherein a time resource of the one or more time resources is associated with a plurality of sensing beams associated with the RIS device.

7. The network unit of claim 3, wherein a time resource of the one or more time resources is associated with one or more sensing beams of the set of sensing beams associated with the RIS device; and a further time resource of the one or more time resources is associated with one or more sensing beams of another set of sensing beams associated with the RIS device.

8. The network unit of claim 2, wherein the first mapping comprises a mapping of a sensing beam of the set of sensing beams associated with the network unit to a single sensing beam.

9. The network unit of claim 2, wherein if the channel access procedure is successful, the at least one processor is further configured to cause the network unit to transmit a second configuration message comprising a second mapping of each of the one or more sensing beams of the set of sensing beams associated with the RIS device with each of one or more transmission beams associated with the RIS device.

10. The network unit of claim 9, wherein the second mapping indicates to configure the RIS device for both uplink and downlink transmissions between the RIS device and a user equipment.

11. The network unit of claim 9, wherein the second mapping indicates to configure the RIS device for only downlink transmissions between the RIS device and a user equipment.

12. A method performed by a reconfigurable intelligent surface (RIS) device, the method comprising:
receiving a first configuration message comprising a first mapping of each of one or more sensing beams of a set of sensing beams associated with a network unit to each of one or more sensing beams of a set of sensing beams associated with the RIS device; and
configuring a plurality of elements of the RIS device based on the first configuration message.

13. A reconfigurable intelligent surface (RIS) device, the RIS device comprising:
a plurality of elements; and
at least one processor, wherein the at least one processor is configured to cause the RIS device to:
receive a first configuration message comprising a first mapping of each of one or more sensing beams of a set of sensing beams associated with a network unit to each of one or more sensing beams of a set of sensing beams associated with the RIS device; and
configure the plurality of elements based on the first configuration message during a channel access procedure performed by the network unit.

14. The RIS device of claim 13, wherein the first mapping comprises, for each of the one or more sensing beams of the set of sensing beams associated with the network unit, one or more time resources, wherein each of the one or more time resources is associated with one or more sensing beams of the set of sensing beams associated with the RIS device.

15. The RIS device of claim 13, wherein the first mapping comprises at least one index, wherein each of the at least one index corresponds to an entry in a preconfigured table stored in a memory accessible to the RIS device, wherein the entry comprises a time resource of one or more time resources, and wherein one or more sensing beams of the set of sensing beams associated with the RIS device are to be output by the RIS device at the time resource.

16. The RIS device of claim 15, wherein the at least one processor is further configured to cause the RIS device to query the preconfigured table with the at least one index to obtain the entry corresponding to each of the at least one index.

17. The RIS device of claim 14, wherein each time resource of the one or more time resources is associated with a respective one or more sensing beams of the set of sensing beams associated with the RIS device.

18. The RIS device of claim 13, wherein if the channel access procedure is successful, the at least one processor is further configured to cause the RIS device to:
receive a third configuration message comprising an indication of one or more channel occupancy times and one or more time resources associated with the one or more channel occupancy times based at least in part on the performed channel access procedure; and
configure the plurality of elements of the RIS device based on the third configuration message.

19. The RIS device of claim 18, wherein the channel access procedure was successful in the one or more time resources.

20. The RIS device of claim 18, wherein the third configuration message comprises a plurality of channel occupancy times and a time resource associated with each of the plurality of channel occupancy times, wherein each of the plurality of channel occupancy times is within a maximum channel occupancy time duration.
